(19) United States
(12) Patent Application Publication
(10) Pub. No.: US 2007/0167114 A1
(43) Pub. Date: Jul. 19, 2007

(54) BRUSHING SYSTEM

(75) Inventors: Norbert Fromel, Herrieden (DE); Caroline Siebert, Mainz (DE); Roland Kalberer, Vilters (CH)

Correspondence Address: PEARNE & GORDON LLP, 1801 EAST 9TH STREET, SUITE 1200, CLEVELAND, OH, 44114-3108, US

(73) Assignee: OC OERLIKON BALZERS AG, Balzers (LI)

(21) Appl. No.: 11/623,332

(22) Filed: Jan. 16, 2007

(30) Foreign Application Priority Data
Jan. 16, 2006 (DE) 20 2006 000645.1

(51) Int. Cl. B24B 51/00; B08B 1/02

(52) U.S. Cl. 451/11; 15/21.1; 15/88.2; 451/285

(57) ABSTRACT

System for processing technical surfaces, in particular surfaces of essentially rotationally symmetrical work pieces (3), comprising at least one processing unit (4) and one motor-driven work-piece carrier (1) and, mounted thereon in rotatable fashion, at least two or more holders (5) that feed work pieces (3) to the processing unit (4), characterized in that the processing unit (4) includes means (6) serving to exert an essentially constant hold-down pressure on the surface of the respective work piece (3), while the motor drive is so designed as to control the feed-in-timing sequence of the work pieces (3) and the duration of their processing cycle in the processing unit (4).

### TECHNICAL FIELD

The invention relates to a brushing system as specified in the independent claim 1.

### DESCRIPTION OF RELATED ART

Brushing machines for finishing technical or decorative surfaces, for instance by deburring, grinding or lapping and polishing, configured as a simple brush stand with manual work-piece feed, have been in existence for a long time. More recently, various types of brushing devices have been developed, designed to permit both a higher level of automation and a more reproducible brushing process.

US 2002037689, for example, describes an automated production center for finishing a variety of parts, in which a processing head, movable along three axes while also being rotatable, is capable of surface-finishing pivotably mounted parts. WO 97/00757 describes an automatic finishing machine for processing sanitary devices. Prior art also includes other types of automated production systems that can be used for brushing operations as well. The drawback of those automated devices, however, is their high degree of complexity due to the need to control manipulators that move along up to six different axes and to regulate and control complex relative movements between the processing robot and the work piece.

Examples thereof include CNC-controlled systems made by Sinjet Osborn and used for surface modification, in particular for the deburring of tools. These systems are technically complex and expensive since in this case as well a CNC control moves a brushing arm along several axes. Guiding the brush to the object surfaces can be accomplished for instance by entering the geometric tool dimensions on the basis of which the corresponding feed parameters are calculated, thus adding another operating step.

A significantly simpler brushing machine design is made by René Gerber AG. That machine works in a batch processing mode, whereby a turret equipped with radially extending holders is loaded with shaft- or shank-type tool bits, whereupon the tool bits are jointly finished by means of a rotating disk-type brush. Upon completion of the brushing process the disk brush is raised and the turret is reloaded. For volume production this type of batch processing with corresponding loading and unloading times can have its drawbacks. Moreover, given the different radial speeds of the brushing tool, the bits are surface-finished at varying rates over the length of the shank, meaning that in the case of long tools the brushing effect will be significantly stronger at the tip than on the sides at the shank. Apart from the respective individual brush-to-load geometry this is one more reason why machines of this type can only process tools of limited length.

### DISCLOSURE OF THE INVENTION

It is therefore the objective of this invention to introduce a brushing system for essentially rotationally symmetrical work pieces that avoids the aforementioned drawbacks of prior art. In particular, it is designed to permit the consistently uniform brushing of work pieces of various diameters and lengths without requiring an additional operating step.

That capability is achieved with a brushing system offering the characteristic features specified in claim 1, with design variations of the invention described in the sub-claims.

The system for the processing of technical surfaces lends itself especially well to the surface-finishing of essentially rotationally symmetrical work pieces and encompasses at least one processing unit, one motor-driven work-piece carrier and, mounted thereon, at least two or more rotatable holders that feed the work pieces to the processing unit. The processing unit includes means for exerting essentially constant hold-down pressure on the work-piece surface while the motor drive is so designed as to control the feed-in timing sequence of the work-pieces and the duration of their processing cycle in the processing unit.

The minimum of one processing unit includes a brushing or grinding device, most preferably a round rotary brush or a belt-type brush. The constant hold-down pressure can be generated by means of gas-pressure dampers, spring-loaded elements, elastic elements or weights and, if necessary, levers. The work-piece carrier may be disk- or belt-shaped, equipped with a continuous, cyclical or stepped feed drive. The holders can be rotated by a separate drive unit such as a gear wheel, a crown gear, a friction wheel, a friction ring or the like or, preferably, by the tangential forces of the processing unit bearing on the circumference of the work pieces.

A system of this type can be used to employ different methods for surface-finishing an essentially cylindrical work piece, as described for instance in the tests per Table 1). It is thus possible to process work pieces provided with different coatings including PVD (physical vapor deposition) or CVD (chemical vapor deposition).

A brushing system thus configured permits the continuous, stepped and/or cyclical transport of the individually rotating work pieces past the brushing stations, allowing simple loading and unloading of the work pieces being treated without having to interrupt the brushing process. Once the brushing devices have been selected and, if necessary, the brush angle has been set, brushing parameters such as timing, hold-down pressure, brushing angle and rotational speed of the brushes will automatically and without any additional operating step adapt themselves to varying work-piece diameters and lengths, assuring a predefined finished state of the processed surfaces. If the object tool bits are not set in rotary motion by the rotation of the brushing devices alone, the individual satellite holder mounts can be caused to rotate for instance by engaging in a stationary crown gear ring, in which case the rotational speed can be varied by means known to those skilled in the art.

It is thus possible with a brushing system according to the invention to advantageously perform on essentially rotationally symmetrical parts all common finishing operations such as smoothing, deburring, corner radiusing, descaling etc.

### BRIEF DESCRIPTION OF THE DRAWINGS

The attached drawings will serve to illustrate several examples of advantageous forms of implementation of the invention, where

FIG. 1 depicts a belt-type brushing system

FIG. 2 shows a round rotary brushing system

FIG. 3 illustrates a linear feed with a belt-type brush

FIG. 4 shows a linear feed with a round rotary brush

FIG. 5a & b illustrate torque measurements

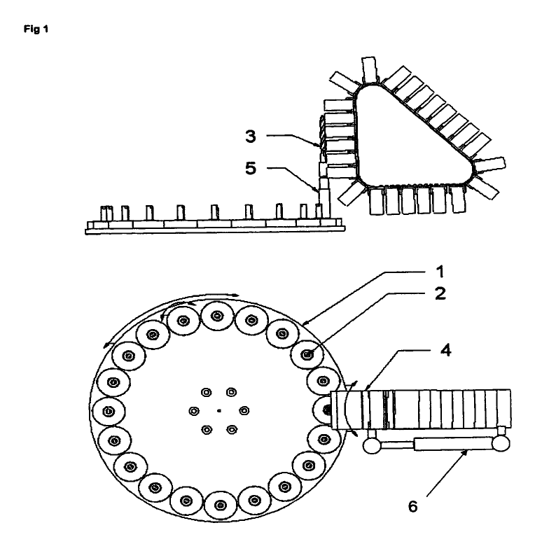

FIG. 1 depicts a belt-type brushing system. It allows the work pieces to be moved without interrupting the revolution, or in a clocked mode. The number and position of the brushes 4 can be varied. Moreover, the brushing distance can be adjusted in traditional fashion (extending the roller spacing and/or extending the belt).

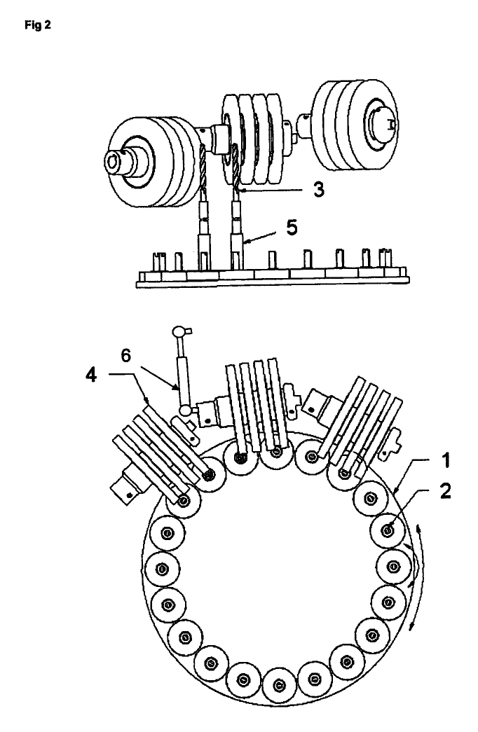

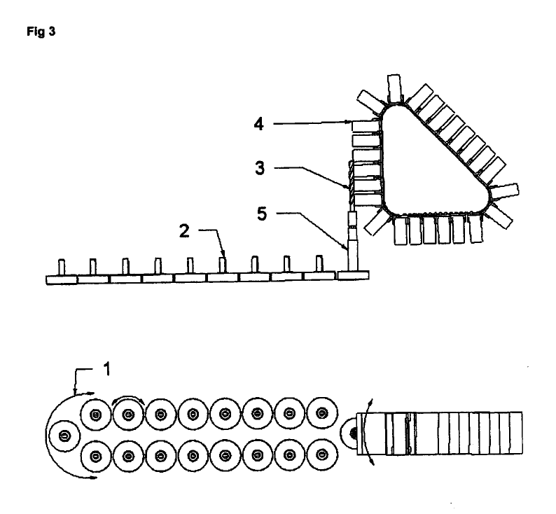

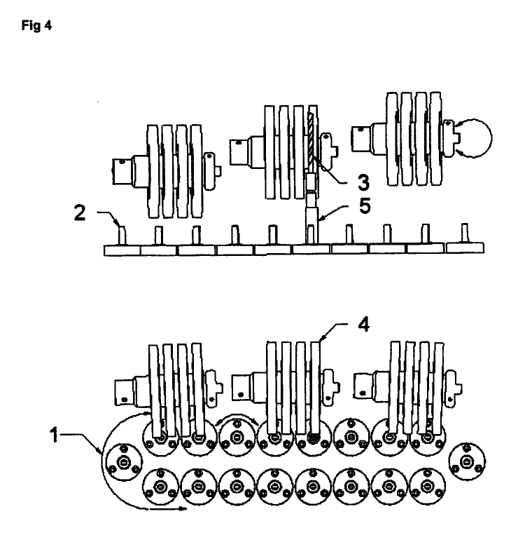

The surface modification (e.g. smoothing, roughing, corner treatment/radiusing, deburring) of rotationally symmetrical work pieces takes place in a pass-through process. To that effect the tool bits 3 are placed in holders 5 which on their part are mounted on rotary satellites 2 and are moved, on a disk 1 as illustrated in FIG. 1 and FIG. 2 or on a revolving belt 1′ as shown in FIG. 3 and FIG. 4, past the brush or brushes 4. The holder 5 with the tool bit 3 rotates around the axis of the satellite 2. The direction and speed of rotation of the disk 1, the belt 1′, the satellite 2 and the brush 4 may be varied as needed (clockwise or counter-clockwise rotation, different angular speeds). In a simple implementation, adequate for many applications, the rotation of the satellite is engendered by the force transferred by the brushes 4 onto the tool bits 3.

As may be necessary, the brush 4 can be set at an angle relative to the work piece, for instance in order to work parallel to the flute angle. Consistently even treatment over the entire length of the tool bit can be attained by positioning the brushes 4, especially round rotary brushes as depicted in FIG. 2 and FIG. 4, in elevationally overlapping fashion. Alternatively, one or several of the brushes 4 can be raised and lowered during the process, preferably parallel to the tool bits. In addition, for instance by means of a gas-pressure-operated damper 6, the brush can be held against the tool bit at a defined compressive force level of 1-100N. Those skilled in the art will know how to employ comparable means for applying pressure on the brush, such as spring-loaded or elastic elements or weights, reinforced by lever action if necessary. It is thus possible to apply a defined, essentially constant pressure on the brush or brushes over the entire object length of the tool bit. Simple and advantageous compensation for differences in diameter and length of the tool bits is purely mechanical without any additional control since the adaptation is self-adjusting. When a tool bit with a larger diameter follows a smaller bit, the brush will automatically shift sideways by the appropriate amount, and vice versa, while for both diameters the pressure applied remains the same. For example, the brush assembly 4 together with the drive motors may be mounted on a swivel arm, not illustrated. The swivel motion may be horizontal or vertical.

The holders 5 may be so designed that they can be simply plugged into the rotary disk or the belt. To prevent the tool bits from rotating within the holders, appropriate clamps or other retaining elements can be provided. For example, a conventional clamping spring may be attached to the holder 5 to adequately secure the tool bit 3 in the holder.

A brushing system of this type lends itself particularly well to the processing of shanked tool bits and rotationally symmetrical components, for instance even with multiple incremental diameters. But shankless rotationally symmetrical tools such as hobbing tools can equally well be processed when mounted on a suitable holder such as a creel-type holder with slip-on mandrel.

Other Advantages of the Invention

A first test with the novel brushing system involved the brushing of CVD- and PVD-coated tools to improve their run-in performance. The following will describe different examples that demonstrate additional advantages offered by this brushing system for PVD-coated tools.

Using a brushing system according to the invention, consisting of a disk with 20 holder satellites and three stationary brushes per FIG. 2, offset in height by 50 mm each, the surfaces of various coated and uncoated tools were brushed at an angle of incidence of about 60 degrees relative to the vertical axis, i.e. to the tool axis. The dimensions of the brushes were selected as follows: Diameter=150 mm, brushing swath width per manufacturers' specifications about 17 mm, with 4-6 individual brushes assembled with spacers into a combined width of about 80-100 mm. The processing time per brush at one of the 3 defined height levels was set at between 5 and 30 sec, with a particularly good result in terms of surface quality and throughput obtained with the selected brushing parameters in an 8 to 10 sec processing cycle. The tool bits were brushed over a functional length of between 1 and 150 mm. In this case a 360-degree rotation of the rotary disk took about 3 minutes. Since several tools could be processed simultaneously, a finished tool was unloaded at the exit and a new unfinished tool loaded every 10 seconds.

With a 40-satellite configuration, using brushes of the selected diameter, it is possible to simultaneously process two tool bits per brushing station, so that even with an unchanged cycle time of 45 seconds twice the throughput per time unit is achievable.

Using a 20-satellite configuration as described above, of a brushing system according to the invention, test samples and tool bits of various parameters as partly shown in Table 1 were brushed. Identified in the second column is the abrasive material (Al₂O₃, SiC), alternating with nylon brushes, or the type of bristles of the brush body itself (brass, fiber=absorbent natural fiber).

TABLE 1

| | | | Wire/Bristle | | Brush | Tool | Disk | Force, | | |
|---|---|---|---|---|---|---|---|---|---|---|
| Test | Abrasive | Grain Size | Diameter | Bristle | Rotation | Rotation | Rotation | Gas-Pressure | Diamond | |
| No. | Medium | (mesh) | [mm] | Length | [RPM] | [RPM] | [RPM] | [N] | Paste | Lubricant |
| 1 | Al₂O₃ | 500 | 0.45 | 35 | 650 | 9 | 0.3 | 30 N | | |
| 2 | Al₂O₃ | 500 | 0.45 | 35 | 650 | 9 | 0.3 | 10 N | | |
| 3 | Al₂O₃ | 800 | 0.25 | 35 | 650 | 9 | 0.3 | 30 N | | |
| 4 | SiC | 1000 | 0.26 | 35 | 650 | 9 | 0.3 | 30 N | | |
| 5 | SiC | 1000 | 0.26 | 35 | 300 | 9 | 0.3 | 30 N | | |
| 6 | SiC | 1000 | 0.26 | 35 | 1300 | 9 | 0.3 | 30 N | | |
| 7 | Brass | n/a | 0.15 | 34 | 300 | 9 | 0.3 | 10 N | 6 μm | WD40 |
| 8 | Fiber | n/a | 0.2 | 34 | 650 | 9 | 0.3 | 30 N | 3 μm | Paste |

The corner radius of tool blades was tested using the different brush bodies with and without abrasives including the addition of diamond paste and a lubricant. The grain size of the diamond particles ranged from 0.25 μm to 15 μm. Under these conditions it was possible to select for tests 1 to 8 a corner radius of between 3 μm and 30 μm, i.e. by using a very small grain size the corner can be maintained in nearly perfect shape while a somewhat larger grain size can produce a defined radius.

Depending on the tool and the application, the brushing system here presented permits the selection of the desired corner radius. For the mass production of particularly delicate tool bits, however, it will be advisable to choose a one-time parameter setting for the maximum permissible corner radius and to maintain the corresponding brushing parameters for all brushing operations. The objective is to stabilize the cutting edge and to even out grinding jags.

A processing operation per test #1, with the disk rotating at 0.3 RPM which corresponds to about 15 sec processing time per brush and height level, was found to be suitable and cost-effective for producing a smooth surface without damaging the PVD layer on the cutting edges.

Processing a multilayer coating consisting of AlCrN and TiSiN monolayers (Balinit® Helica) improved the roughness values as follows:

| | |
|---|---|
| Pre-treatment roughness: | Rₐ 0.22, R_{z} 4.47, Rₚ 4.07; |
| Post-treatment roughness: | Rₐ 0.22, R_{z} 2.47, Rₚ 1.72. |

It is striking that, while the mean roughness value Rₐ remains unchanged, the averaged roughness depth R_{z} and the smoothing depth Rₚ improved by about 50%. This change in characteristic values indicates the retention of the basic roughness and the simultaneous elimination of roughness peaks.

For more delicate tools the parameters per test #3 with a grain size of F800 are recommended. Starting with the same initial surface condition, the post-treatment roughness measurements resulted in the values summarized in Table 2):

TABLE 2

| Test Object | Coating | Post-Processing | Rₐ | R_{z} | Rₘₐₓ |
|---|---|---|---|---|---|
| Bolt, HSS | Helica | None | 0.225 | 2.06 | 2.76 |
| Bolt, HM | Helica | None | 0.273 | 2.38 | 2.73 |
| Bolt, HSS-1 | Helica | Test #3 | 0.077 | 0.77 | 1.25 |
| Bolt, HSS-2 | Helica | Test #3 | 0.077 | 1.11 | 1.43 |
| Bolt, HM-1 | Helica | Test #8 | 0.037 | 0.48 | 0.69 |
| Bolt, HM-2 | Helica | Test #8 | 0.036 | 0.57 | 0.71 |

Appropriate surface processing can reduce the negative effects inherent in the use of a new tool between 20 and 50%, thus significantly improving the run-in pattern of these tools and minimizing the danger of a chipped corner or stripped coating and similarly undesirable occurrences during run-in.

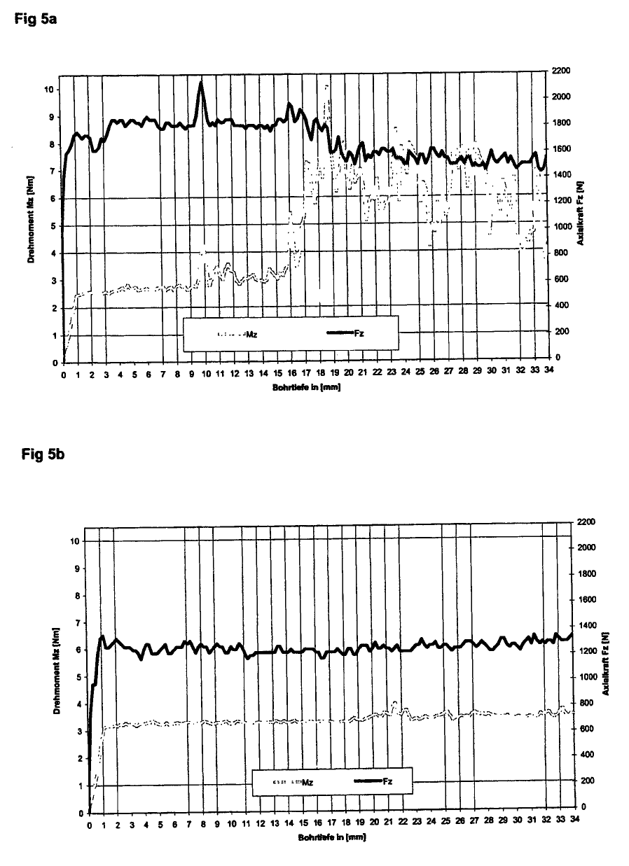

FIG. 5a and b respectively show the torque and axial force curve of two hard-coated carbide steel drill bits model Alpha A3365 made by Titex, with a diameter d=6.8 mm, drilling into CK45. Processing parameters: Cutting speed Vc=120 m/min, advance rate f=0.2 mm/rev. Both tools had been provided, in a Balzers RCS spark evaporation system, with a multilayer coating consisting of AlCrN and TiSiN monolayers (Balinit® Helica) for a total coating thickness of about 4 μm. One tool was then tested, without post-treatment, and the curve of the torque M_{z} (left ordinate axis) and the axial force F_{z} (right ordinate axis) in relation to the drill penetration depth was plotted as shown in FIG. 5a. In this case the axial force and the torque follow mutually opposite directions. While the axial force, at very high initial values of between 1,700 and 2,000 Nm, gradually drops to a value of about 1,500 Nm, the torque of the tool, between 16 and 18 mm, rises from 3 to 9 Nm, subsequently receding again with strong fluctuations. By contrast, as illustrated in FIG. 5b, a coated drill brushed under test #1 conditions with a 30 N hold-down pressure at 650 revolutions displays a perfectly even, low-level force pattern. Analogous results were obtained in all comparisons between coated-only and coated-and-brushed drill bits.

Reference Numbers

1 Rotary disk/revolving belt
2 Satellite
3 Tool bit
4 Brush unit
5 Holder
6 Gas-pressure-operated damper

What is claimed is:

1. System for processing technical surfaces and in particular the surfaces of essentially rotationally symmetrical work pieces (3), encompassing at least one processing unit (4) and one motor-driven work-piece carrier (1) and, mounted thereon in rotatable fashion, at least two or more holders (5) that feed work pieces (3) to the processing unit (4), characterized in that the processing unit (4) includes means (6) serving to exert an essentially constant hold-down pressure on the surface of the work pieces (3), while the motor drive is so designed as to control the feed-in timing sequence of the work pieces (3) and the duration of their processing cycle in the processing unit (4).

2. System as in claim 1, characterized in that at least one processing unit (4) comprises a brushing or grinding unit but preferably a rotary-disk or a belt-type brush.

3. System as in one of the preceding claims, characterized in that the means (6) include at least one gas-pressure-operated damper, spring elements, elastic elements or weights and, if necessary, lever elements.

4. System as in one of the preceding claims, characterized in that the work-piece carrier (1) is disk- or belt-shaped.

5. System as in one of the preceding claims, characterized in that the motor drive is a continuous, cyclical or stepped feed drive.

6. System as in one of the preceding claims, characterized in that the holders (5) can be rotated by the tangential force of the processing unit (4) bearing on the circumference of the work pieces (3).

7. System as in one of the preceding claims, characterized in that the holders (5) can be rotated by separate drive mechanisms.

8. System as in one of the preceding claims, characterized in that the drive mechanisms include a gear wheel and crown gear ring, a friction wheel and friction ring or the like.
